(19) United States
(12) Patent Application Publication
(10) Pub. No.: US 2013/0100705 A1
(43) Pub. Date: Apr. 25, 2013

(54) Luminaire

(71) Applicant: Yu-Chiang HSIEH, Taipei City (TW)

(72) Inventor: Yu-Chiang HSIEH, Taipei City (TW)

(21) Appl. No.: 13/293,142

(22) Filed: Nov. 10, 2011

(30) Foreign Application Priority Data
Oct. 24, 2011 (CN) 201120407600.1

(51) Int. Cl. H01R 33/00

(52) U.S. Cl. 362/647

(57) ABSTRACT

A luminaire includes a power supply tank and a light emitting unit. A wall of the power supply tank is constituted by an electric conductor and a bottom end of an interior of the tank is a conductive seat formed by an electric conductor. A top end of the wall connects electrically a conductive disc which includes a penetrative insertion hole. The light emitting unit includes a luminous element and an electrode pole on a bottom end of the luminous element. A body of the electrode pole includes the insertion hole to increase electric conduction by contact; whereas, through the insertion hole, a diversified change can be even manifested after inserting the light emitting unit. In addition, a bottom of an outer casing provided by the power supply tank includes a counter weight, so that the luminare will not fall down easily and can be used more safely.

### BACKGROUND OF THE INVENTION

a) Field of the Invention

The present invention relates to a luminaire, and more particularly to a luminaire showing a pattern of flower arrangement in a vase.

b) Description of the Prior Art

Referring to FIG. 1, it shows a structural schematic view of a conventional luminaire, comprising primarily a power supply tank 10 and at least a light emitting unit 20, wherein a wall 11 of the power supply tank 10 is constituted by an electric conductor, and a bottom end of an interior of the power supply tank 10 is provided with a conductive seat 12 made by an electric conductor. Several insulators 13 are provided between the conductive seat 12 and the wall 11 to form open-circuit.

The light emitting unit 20 is inserted into the power supply tank 10 and is provided with a luminous element 21 and an electrode pole 22 that is emplaced on a bottom end of the luminous element 21. A body of the electrode pole 22 contacts the wall 11 to constitute a first electric conductor 23 that connects electrically between the luminous element 21 and the abovementioned wall 11; whereas, a bottom end of the electrode pole 22 is a second electric conductor 24 that connects electrically between the luminous element 21 and the abovementioned conductive seat 12.

However, the abovementioned luminaire is provided with following shortcomings when being implemented:
1. A top opening at the wall of the power supply tank is too big that it is not easy to fix the light emitting element and arrange a shape thereof. In addition, a decoration effect is inferior.
2. A contact point between the first electric conductor and the wall is too small that it is easy to cause loose contact.
3. The electrode is directly exposed out of a tank hole and thus is easily contacted by a mistake by a user to cause short-circuit or danger.
4. If the power supply tank is inserted with too many electrode poles, power of a transformer will be overloaded to cause short-circuit or danger.
5. If the power supply tank is inserted with too many electrode poles, the power supply tank can fall down easily due to instability, resulting in damage or danger.

As a result, the abovementioned luminaire is modified, such that the light emitting unit can be arranged with diversity and the inferior effect of the shape arrangement, the loose contact, the contact of the electrode by a mistake, the short-circuit, the falling down of the power supply tank as well as leak of electricity, for the conventional luminaire, can be improved.

### SUMMARY OF THE INVENTION

The primary object of the present invention is to provide a lamp-set structure wherein a lamp cap can be dismantled from a lamp body and replaced.

Another object of the present invention is to provide a lamp-set structure wherein a lamp cap and a lamp holder can be engaged robustly and can be electrically connected, through mutual engagement of lamp cap latching parts, lamp holder fastening parts and exposed electric contacts.

To achieve the aforementioned object, the lamp-set structure of the present invention includes a lamp cap and a lamp body, wherein an interior of the lamp cap is accommodated with more than one illuminating element which is electrically connected with a circuit board, and the other end of the circuit board is provided with electric contacts which are exposed at a bottom of the lamp cap. Through the provision of the electric contacts, an electric source can be conducted on the circuit board, allowing the illuminating elements on the circuit board to illuminate. Peripheries of the lamp cap are provided with more than one latching part which can be a rectangular strip.

The lamp body includes a handheld part and a lamp holder. An interior of the lamp holder is provided with fastening parts which correspond with the latching parts of the lamp cap. Each fastening part can be an L-shaped locking slot, allowing each rectangular strip of the lamp cap to be latched and fixed with the lamp holder through the L-shaped locking slot. The lamp holder is provided with connection contacts which correspond with the electric contacts of the lamp cap. Through electric contact of the electric contacts with the connection contacts, electric energy on the lamp body can be transmitted to the lamp cap. The handheld part of the lamp body is provided with a control switch to control on and off of the illuminating element of the lamp cap. Through the mutual engagement of the lamp cap latching parts, the lamp holder fastening parts, the exposed electric contacts and connection contacts, the lamp cap can not only be stably and electrically connected, but be dismantled and replaced.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a structural schematic view of a conventional luminaire.

FIG. 2 shows a structural schematic view of a first embodiment of the present invention.

FIG. 3 shows a structural schematic view of a light emitting unit of the first embodiment of the present invention.

FIG. 4 shows a pattern of implementation of the light emitting unit of the first embodiment of the present invention.

FIG. 5 shows another pattern of implementation of the light emitting unit of the first embodiment of the present invention.

FIG. 6 shows a first structural schematic view of a second embodiment of the present invention.

FIG. 7 shows a second structural schematic view of the second embodiment of the present invention.

FIG. 8 shows a structural schematic view of a third embodiment of the present invention.

FIG. 9 shows a structural schematic view of a fourth embodiment of the present invention.

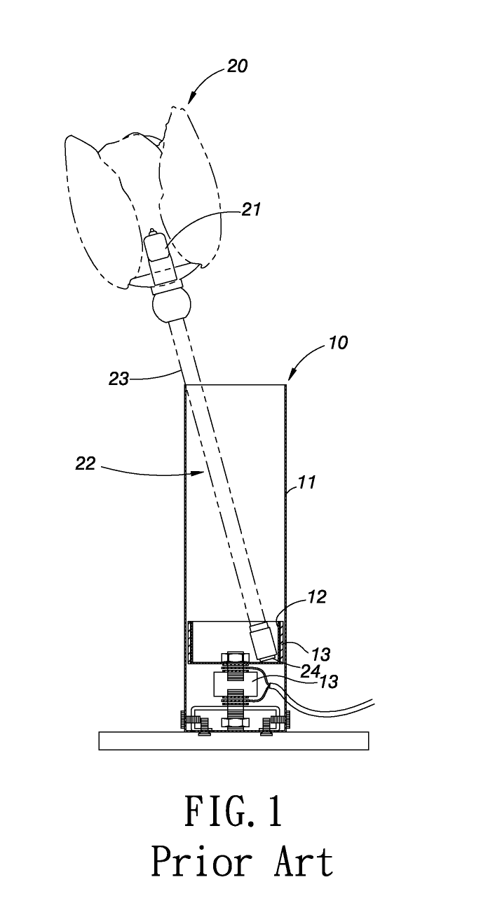

### DETAILED DESCRIPTION OF THE PREFERRED EMBODIMENTS

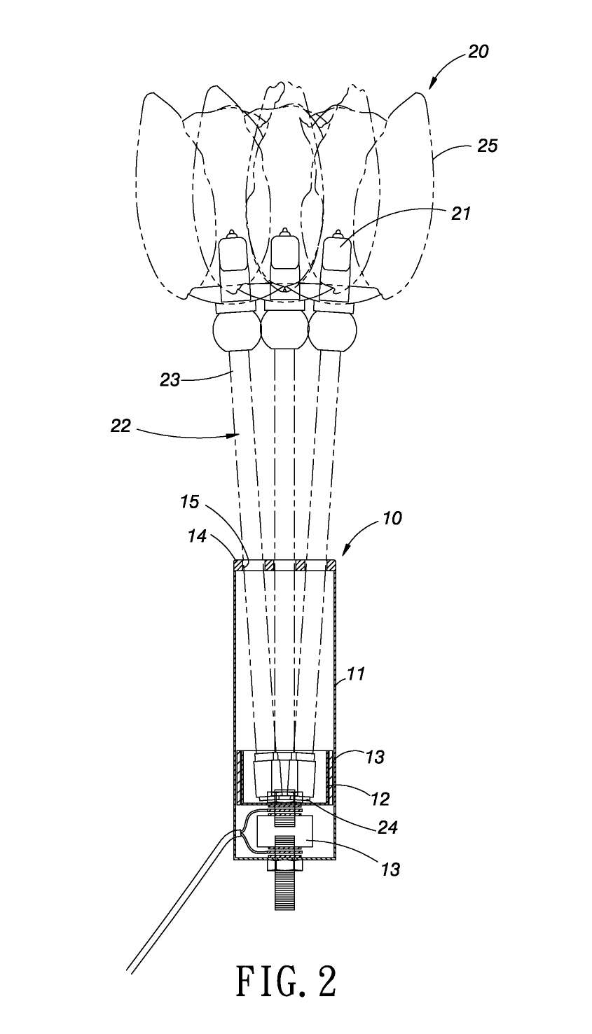

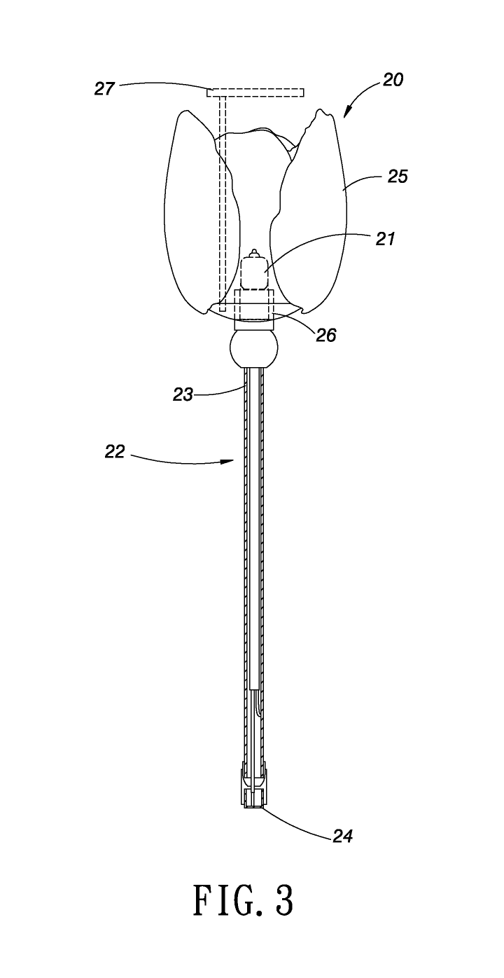

Referring to FIG. 2 and FIG. 3, it shows a structural schematic view of a first embodiment, and a structural schematic view of a light emitting unit of the first embodiment, of the present invention. The luminaire comprises at least a power supply tank 10 and at least a light emitting unit 20, wherein a wall 11 of the power supply tank 10 is constituted by an electric conductor and a bottom end of an interior of the power supply tank 10 is provided with a conductive seat 12 formed by an electric conductor. An insulator 13 is provided between the conductive seat 12 and the wall 11 to form open-circuit, and a top end of the wall 11 is electrically connected with a conductive disc 14 which is provided with at least a penetrative insertion hole 15.

The light emitting unit 20 is inserted into the power supply unit 10 and is provided with a luminous element 21 and an electrode pole 22 that is provided on a bottom end of the luminous element 21. A body of the electrode pole 22 contacts the wall 11 and a first electric conductor 23 is formed by electric connection between the luminous element 21 and the wall 11; whereas, a bottom end of the electrode pole 22 is formed with a second electric conductor 24 by electric connection between the luminous element 21 and the conductive seat 12. As an aperture of the insertion hole 15 of the conductive disc 14 is approximately equal to a diameter of the electrode pole 22, a conduction effect by contacting the first electric conductor 23 can be increased significantly. In addition, by arranging the insertion hole 15, arrangement and layout of the light emitting unit 20 can be changed, thereby achieving an effect of decoration with diversity. Besides, a number of the insertion hole 15 of the conductive disc 14 can be changed according to power of a transformer, so as to prevent a user from inserting too many electrode poles 22 that the transformer is overloaded and thus damaged. In addition, the light emitting unit 20 further includes plural petal units 25 which are provided at peripheries of the luminous elements 21. The petal unit 25 can be connected to a sleeve 26 at a bottom edge of the periphery of the luminous element 21 by all kinds of means, including welding. When implementing, a light barrier 27 can be further provided on a top end of the luminous element 21.

According to an angle of insertion of the electrode pole 22, the abovementioned petal unit 25 can be bent or pre-configured with all kinds of angles, not limited to the angle as shown in the drawings. Furthermore, a surface of the petal unit 25 can be performed with a surface treatment, like color painting, so that the petal unit 25 can manifest a more fantastic decoration effect. In addition, by adjusting an angle of the light barrier 27, light from the luminous element 21 can operate on the petal unit 25 to manifest a more enriched change of illumination, through direct beaming or reflection.

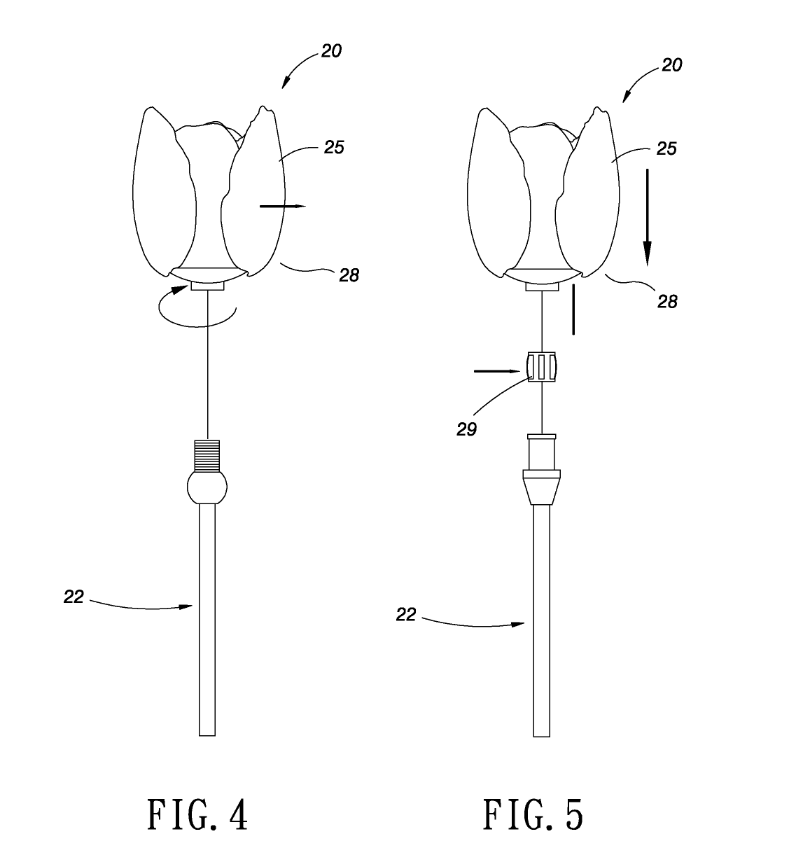

Referring to FIG. 4 and FIG. 5, it shows a pattern of implementation and another pattern of implementation of the light emitting unit of the present invention, wherein a head 28 that is formed by the petal units 25 and peripheral components is fixed on a top of the electrode pole 22 by screwing or sheathing with a connector 29 or other means, so as to facilitate modularized production and assembly of the light emitting unit 20 and to allow the user to change the head of various types easily and freely.

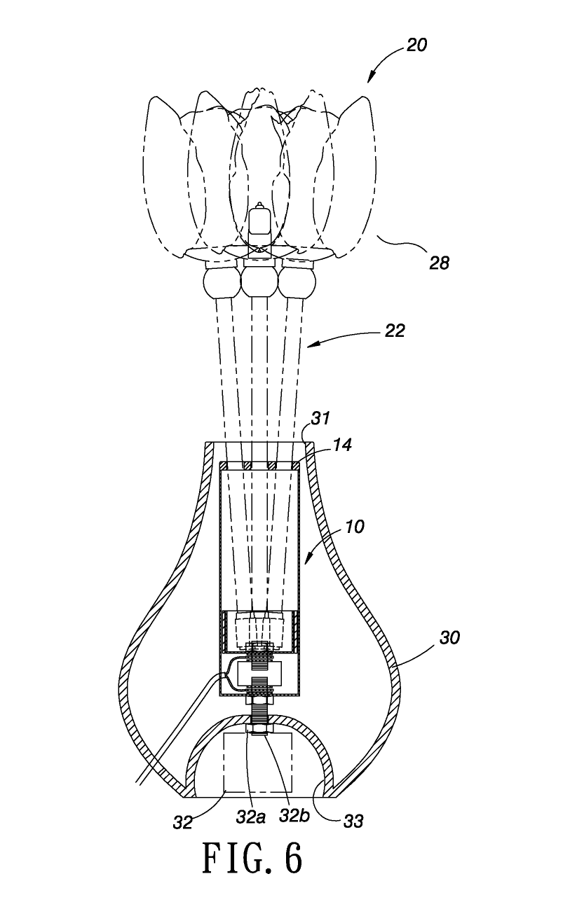

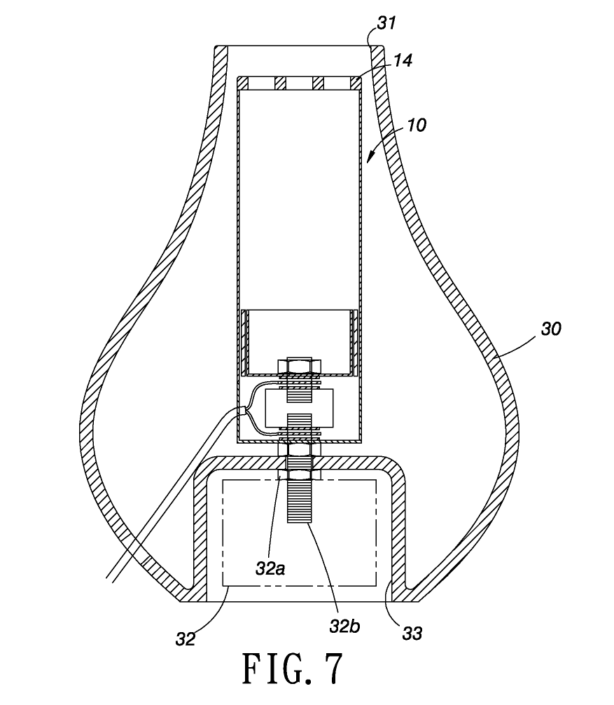

Referring to FIG. 6 and FIG. 7, it shows a first structural schematic view and a second structural schematic view of a second embodiment of the present invention, further including an outer casing 30 that is fixed relatively with the power supply tank 10 and covers the power supply tank 10. The outer casing 30 can be made by all kinds of materials, such as ceramic, glass or metal, and is provided with an opening 31 corresponding to the conductive disc 14, so that the outer casing 30 can be utilized to protect the power supply tank 10. In addition to being provided with a safe blocking function to prevent the user from contacting the power supply tank 10 directly, a shape and color paint of the outer casing 30 can be employed, allowing the luminaire to result in a higher decoration effect and economic value. Besides, a bottom of the outer casing 30 can be further provided with a counter weight 32 and upon implementing, the counter weight 32 can be buried in a counter weight space 33 on a bottom end of the outer casing 30 or be exposed out of the bottom end of the outer casing 30. In the present embodiment, the counter weight 32 is a nut 32a that is provided at the bottom of the casing 30 and the nut 32a can be bolted on a screw 32b that is extended downward from the power supply tank 10 and penetrates out of the casing 30 to enter into the counter weight space 33. A size and quantity of the nut 32a, as well as a length of the screw 32b can be changed according to a requirement of the counter weight. Of course, the counter weight 32 can be further implemented by other shapes that can be contained in the counter weight space 33. By provision of the counter weight 32, the luminaire can be prevented from falling down or sliding to be damaged due to instability, as the power supply tank 10 is inserted with too many electrode poles 22 that are configured with the heads 28. Therefore, the luminare can be used more safely. On the other hand, the counter weight 32 and the counter weight space 33 can be configured with all kinds of sizes, scales and shapes according to demands, thereby developing the best anti-falling-down effect.

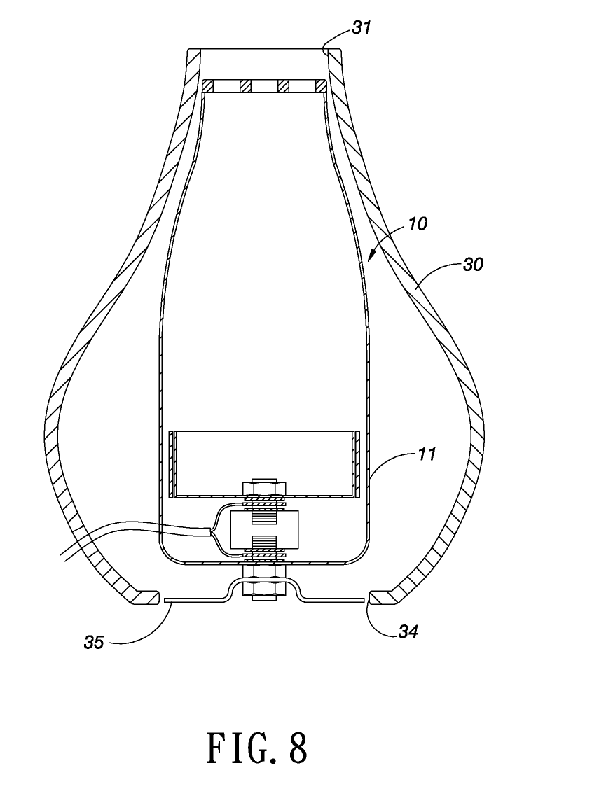

Referring to FIG. 8, it shows a structural schematic view of a third embodiment of the present invention, wherein the bottom of the outer casing 30 is provided with an intake port 34 for emplacing the power supply tank 10 and the largest diameter of the wall 11 is smaller than an aperture of the opening 31 of the outer casing 30, so that the power supply tank 10 can be easily emplaced from the bottom of the outer casing 30 for assembly. After the power supply tank 10 has been emplaced into the outer casing 30, the power supply tank 10 can be sealed inside the outer casing 30 by a closing component 35. Besides, as the outer casing 30 is designed in a shape of a roly-poly with a wide bottom and a narrow top, the anti-falling-down counter weight effect can be achieved, as well. On the other hand, the closing component 35 at the bottom can be replaced by the closing component 35 of various size, thickness or material as needed, so as to produce an auxiliary counter weight effect by the closing component 35; whereas, the bottom end of the outer casing 30 or closing component 35 can be further provided with a counter weight to prevent the luminaire from falling down.

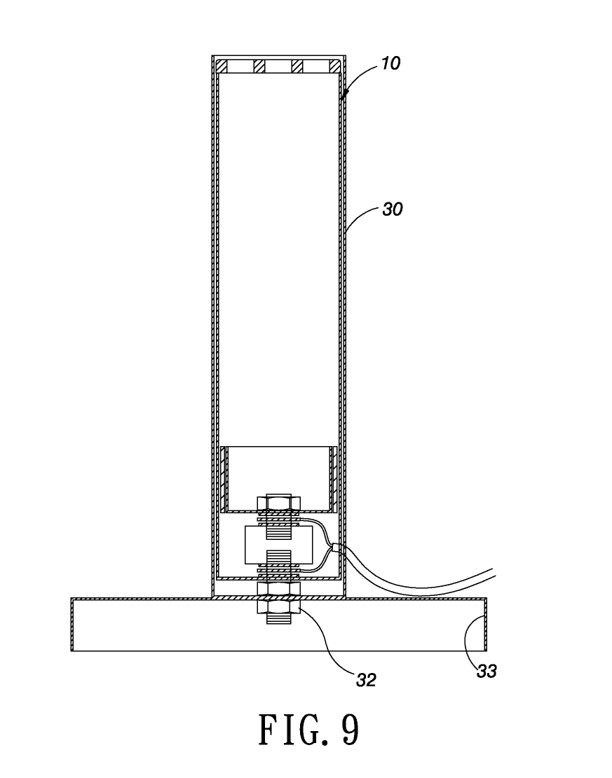

Referring to FIG. 9, it shows a structural schematic view of a fourth embodiment of the present invention. The outer casing 30 of the present embodiment is in a shape of a barrel, and the counter weight 32 is located in the counter weight space 33 at the bottom of the outer casing 30. The bottom of the counter weight space 33 is a platform seat with a width larger than an outer diameter of the outer casing 30, thereby allowing the luminaire to be more stable without falling down easily.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A luminaire comprising:
a power supply tank, a wall of the power supply tank being constituted by an electric conductor and a bottom end of an interior of the power supply tank being provided with a conductive seat formed by an electric conductor, an insulator being provided between the conductive seat and the wall to form open-circuit, a top end of the wall being electrically connected with a conductive disc, and the conductive disc being provided with a penetrative insertion hole; and
a light emitting unit, the light emitting unit being provided with a luminous element and an electrode pole on a bottom end of the luminous element, a body of the electrode pole contacting the insertion hole to form a first electric conductor that connects electrically between the luminous element and the conductive disc, and a bottom end of the electrode pole being formed with a second electric conductor that connects electrically between the luminous element and the conductive seat.

2. The luminaire according to claim 1, further comprising an outer casing that is fixed relatively with the power supply tank and covers the power supply tank, the outer casing being provided with an opening corresponding to the conductive disc.

3. The luminaire according to claim 2, wherein a bottom of the outer casing is provided with a counter weight space to emplace a counter weight.

4. The luminaire according to claim 2, wherein a bottom of the outer casing is provided with an intake port for emplacing the power supply tank and the largest diameter of the wall is larger than an aperture of the opening.

5. The luminaire according to claim 1, wherein a top of body of the electrode pole is provided with a head, and the electrode pole body is combined with the head by screwing or sheathing with a connector.

6. The luminaire according to claim 1, wherein the light emitting unit further comprises plural petal units at a periphery of the luminous element; the petal unit being connected to a sleeve at a bottom edge or a periphery of the luminous element through welding.

7. The luminaire according to claim 5, wherein the light emitting unit further comprises a light barrier at a top end of the luminous element.

8. A luminaire comprising:
a power supply tank, a wall of the power supply tank being constituted by an electric conductor and a bottom end of an interior of the power supply tank being provided with a conductive seat formed by an electric conductor, an insulator being provided between the conductive seat and the wall to form open-circuit;
an outer casing, the outer casing fixing relatively the power supply tank and covering the power supply tank, the outer casing being provided with an opening corresponding to a top end of the wall;
a counter weight space, the counter weight space being provided on a bottom end of the outer casing for emplacing a counter weight; and
a light emitting unit, the light emitting unit being provided with a luminous element and an electrode pole on a bottom end of the luminous element, a body of the electrode pole being a first electric conductor that connects electrically between the luminous element and the wall, and a bottom end of the electrode pole being a second electric conductor that connects electrically between the luminous element and the conductive seat.

9. The luminaire according to claim 8, wherein a top end of the wall is connected electrically with a conductive disc, the conductive disc is provided with a penetrative insertion hole, and the first electric conductor contacts the insertion hole to connect electrically the wall through the conductive disc.

10. The luminaire according to claim 8, wherein a top of body of the electrode pole is provided with a head, and the electrode pole body is combined with the head by screwing or sheathing with a connector.

11. The luminaire according to claim 8, wherein the light emitting unit further includes plural petal units at a periphery of the luminous element, the petal unit being connected to a sleeve at a bottom edge or a periphery of the luminous element through welding.

12. The luminaire according to claim 11, wherein the light emitting unit further includes a light barrier at a top end of the luminous element.
